(19) United States
(12) Patent Application Publication
(10) Pub. No.: US 2019/0035033 A1
(43) Pub. Date: Jan. 31, 2019

(54) Repatriation of Otherwise Non-Qualifying Income Into an Affiliated Publicly Traded Partnership

(71) Applicant: Valhil Moore & Co., LLC, Houston, TX (US)

(72) Inventor: James E. Vallee, Houston, TX (US)

(73) Assignee: Valhil Moore & Co., LLC, Houston, TX (US)

(21) Appl. No.: 15/663,519

(22) Filed: Jul. 28, 2017

(51) Int. Cl. G06Q 40/00; G06Q 20/22; G06Q 20/38

(52) U.S. Cl. CPC G06Q 40/128; G06Q 40/123; G06Q 20/38; G06Q 20/22; G06Q 40/10

(57) ABSTRACT

A Sponsor, the Sponsor being a C-corporation, forms a general partner entity (GPE) owned and controlled by the Sponsor. The Sponsor forms a publicly traded master limited partnership (PTMLP) with the GPE as general partner. The GPE has control over the PTMLP. The PTMLP has an equity quantity of equity units. The Sponsor receives a Sponsor-share portion of the equity quantity of equity units in the PTMLP in exchange for transferring to the PTMLP the right to acquire an asset which produces “qualifying income,” as defined in 26 USC § 7704(d). The PTMLP acquires the asset at a first price and sells it to the Sponsor at a second price, higher than the first price, to produce proceeds. A valuation of the PTMLP considers the proceeds. A valuation of the Sponsor is affected by the proceeds and by the Sponsor-share of the equity quantity of equity units in the PTMLP.

### BACKGROUND

Many corporations, such as airlines, common carriers, large industrial manufacturers, and electric utilities, make use of large quantities of natural resources, such as fuels. Such corporations are often not able to provide their stockholders with periodic streams of income, such as dividends, because of the capital intensive nature of their businesses. In contrast, master limited partnerships (MLPs), which are publicly traded partnerships, provide such streams of tax-advantaged income to its partners if 90 percent or more of an MLP's gross income consists of “qualifying income,” as that term is defined in 26 U.S.C § 7704 (d)(1), and, consequently, typically have higher valuation multiples than corporations. Creating a corporate structure that allows a corporation making use of large quantities of natural resources to take advantage of this aspect of MLPs is a challenge.

### BRIEF DESCRIPTION OF THE DRAWINGS

FIG. 1 is a chart showing a business structure in which the purchasing of an asset that produces qualifying income has been moved to an entity that qualifies for pass-through tax treatment.

FIG. 2 is a flow chart for creating such a business structure.

FIG. 3 is a chart showing a business structure in which the purchasing of an asset that produces qualifying income has been moved to an entity that qualifies for pass-through tax treatment.

FIG. 4 is a flow chart for creating such a business structure.

FIG. 5 is a block diagram of a computer.

### DETAILED DESCRIPTION

The following detailed description illustrates embodiments of the present disclosure. These embodiments are described in sufficient detail to enable a person of ordinary skill in the art to practice these embodiments without undue experimentation. It should be understood, however, that the embodiments and examples described herein are given by way of illustration only, and not by way of limitation. Various substitutions, modifications, additions, and rearrangements may be made that remain potential applications of the disclosed techniques. Therefore, the description that follows is not to be taken as limiting on the scope of the appended claims. In particular, an element associated with a particular embodiment should not be limited to association with that particular embodiment but should be assumed to be capable of association with any embodiment discussed herein.

The federal income tax treatment of a “C” corporation is governed by 26 USC, Subtitle A, Chapter 1, Subchapter C, i.e., 26 USC § 301 et seq. As such, a C corporation's distributions of its profits to its shareholders are taxed twice. The C corporation is taxed on its profits at the entity level and the shareholder who receives a distribution of the profits is taxed again on the distribution.

In contrast, a partnership, whose federal income tax treatment is governed by 26 USC, Subtitle A, Chapter 1, Subchapter K, i.e., 26 USC § 701 et seq., is not subject to federal income taxes. The profits or losses of the partnership “pass through” the partnership as distributions or allocations to the partners and the partners pay federal income tax on such distributions.

A master limited partnership (MLP), or publicly-traded partnership, combines the pass-through characteristics of a partnership with the C corporation's ability to raise capital from public company investors through a stock market.

Under 26 USC § 7704 an MLP is treated as a corporation, and thus is not eligible for the pass-through advantages of a partnership, unless 90 percent of more of the gross income of the MLP for a taxable year consists of “qualifying income,” which is defined in 26 USC § 7704(d)(1), as follows:

“Except as otherwise provided in this subsection, the term ‘qualifying income’ means

(A) interest,

(B) dividends,

(C) real property rents,

(D) gain from the sale or other disposition of real property (including property described in section 1221(a)(1)),

(E) income and gains derived from the exploration, development, mining or production, processing, refining, transportation (including pipelines transporting gas, oil, or products thereof), or the marketing of any mineral or natural resource (including fertilizer, geothermal energy, and timber), industrial source carbon dioxide, or the transportation or storage of any fuel described in subsection (b), (c), (d), or (e) of section 6426, or any alcohol fuel defined in section 6426(b)(4)(A) or any biodiesel fuel as defined in section 40A(d)(1),

(F) any gain from the sale or disposition of a capital asset (or property described in section 1231(b)) held for the production of income described in any of the foregoing subparagraphs of this paragraph, and

(G) in the case of a partnership described in the second sentence of subsection (c)(3), income and gains from commodities (not described in section 1221(a)(1)) or futures, forwards, and options with respect to commodities.

For purposes of subparagraph (E), the term ‘mineral or natural resource’ means any product of a character with respect to which a deduction for depletion is allowable under section 611; except that such term shall not include any product described in subparagraph (A) or (B) of section 613(b)(7).”

Of interest here, corporations that are very large consumers of the assets that produce qualifying income are not eligible for the pass-through treatment that is accorded MLPs under this provision. For example, a C-corporation airline that uses enormous amounts of jet fuel purchased from perhaps many providers, who may qualify for pass-through treatment, does not, simply because of its corporate structure, quality for this treatment. This disparate treatment may adversely affect the valuation of a corporation.

One method of estimating the value of a company is to multiply the earnings before interest, tax, depreciation and amortization (EBITDA) of the company by an EBITDA valuation multiple. Typically, the EBITDA valuation multiple for a MLP is higher than that of a C corporation in the same industry, at least in part because part of the return to investors from an MLP is yield based. That is, investors give greater value to MLPs that produce “mailbox money” in the form of the pass-through distributions than to other corporate forms that do not have such distributions or whose distributions, such as corporate dividends, are small, infrequent, or unpredictable. As described in JIMMY VALLEE, GIANT SHIFTS: ENERGY TRENDS RESHAPING AMERICA′S FUTURE 109-10 (Sutton Hart Press 2017), the importance and value of yield based securities is likely to increase as the Baby Boomer generation retires and desires “a constant stream of checks in the mail—‘mailbox money’—to provide them income for daily life.”

In this disclosure, a C-corporation, or another business entity that does not qualify for pass-through tax treatment and that consumes the assets that produce qualifying income, moves the right to acquire the assets into a business entity that does qualify for the pass-through treatment.

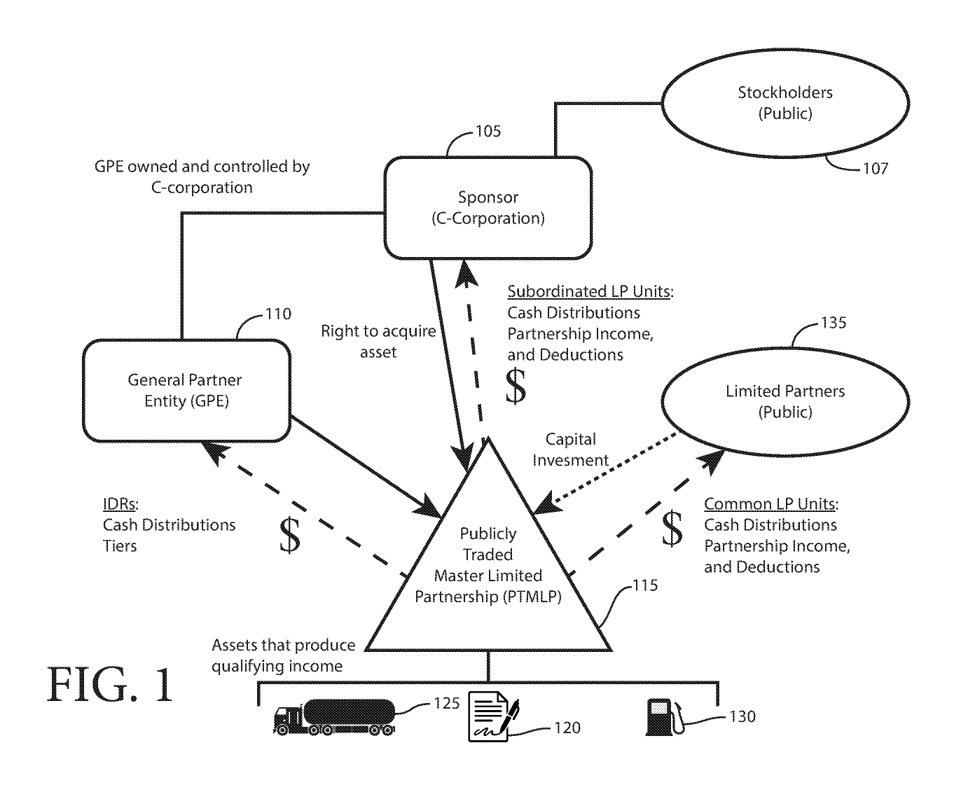

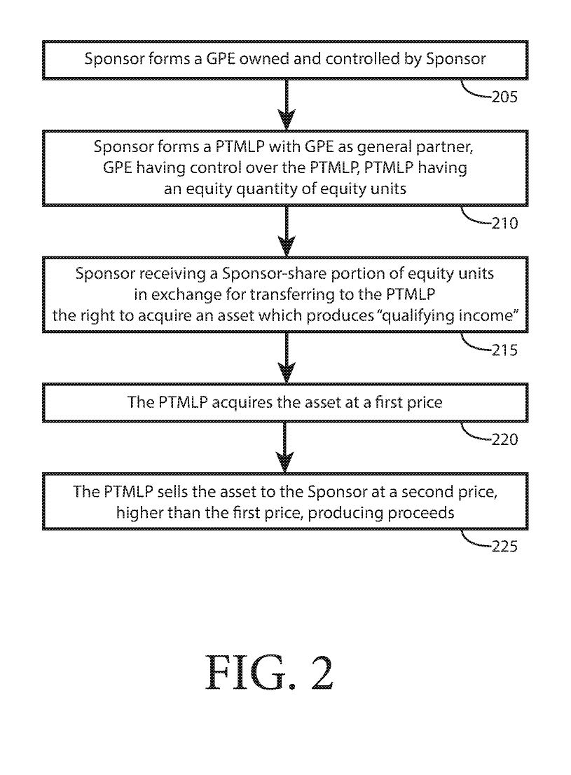

FIG. 1 is a chart showing a business structure in which the purchasing of an asset that produces qualifying income has been moved to an entity that qualifies for pass-through tax treatment. FIG. 2 is a flow chart for creating such a business structure. A Sponsor 105, which can be a C-corporation and which may have stockholders 107 (i.e., the public), forms a general partner entity (GPE) 110, which can be a C-corporation, a limited liability company, or a limited partnership (block 205). The GPE 110 is owned and controlled by the Sponsor 105.

The Sponsor 105 also forms a publicly traded master limited partnership (PTMLP) 115 (block 210). Such PTMLPs are required to have one general partner and at least one limited partner. The GPE 110 is the general partner of the PTMLP 115. The GPE 110 has control over the PTMLP 115. In one or more embodiments, the GPE 110 has management and governance control over the PTMLP 115.

The PTMLP 115 has an equity quantity of equity units. In one or more embodiments, the equity quantity of equity units includes a common-unit quantity of common units. Common units are similar to shares in a C-corporation and can be sold on a stock exchange, such as the New York Stock Exchange (NYSE), or the like. Distributions from the PTMLP 115 are apportioned to holders of common units according to the holder's percentage share of the common units.

In one or more embodiments, the equity quantity of equity units includes a subordinated-unit quantity of subordinated units. Subordinated units are similar to common units except that they do not receive any distributions until distribution targets for the common units have been met. Subordinated units are permanently converted to common units when specified distributions have been made to the holders of common units. Distributions among the subordinated-unit holders are apportioned according to the holder's percentage share of the subordinated units.

In one or more embodiments, the equity quantity of equity units includes an incentive-distribution-right quantity of incentive-distribution-right units. Incentive-distribution-right units determine how distributions are divided between the general partner and the limited partners. Table 1 is an example:

TABLE 1

| | | | Gen'l |
|---|---|---|---|
| | | LP Unit | Partner's |
| | Annualized | Holders' % of | % of |
| Incentive Distribution | Distributions/ | Distribution | Distribution |
| Rights | LP Unit | Cash Flow | Case Flow |
| Tier 1 - Minimum | $1.00 | 98% | 2% |
| Quarterly Distribution | | | |
| (MQD); Annualized | | | |
| Tier 2, Initial, >$1.00 | $1.16 | 98% | 2% |
| to $1.16 | | | |
| Tier 3, >$1.16 to $1.75 | $1.75 | 83% | 15% |
| Tier 4, >$1.75 to $2.33 | $2.33 | 75% | 25% |
| Tier 5, above $2.33 | >Tier 4 | 50% | 50% |

Upon forming the PTMLP 115, the Sponsor 105 receives a Sponsor-share portion of the equity quantity of equity units (block 215). In one or more embodiments, the Sponsor 105 receives all of the subordinated-unit quantity of the subordinated units of the PTMLP 115 and a Sponsor-share quantity of the common-unit quantity of common units.

In exchange, the Sponsor 105 transfers to the PTMLP 115 the right to acquire an asset which produces “qualifying income,” as defined in 26 USC § 7704(d). In one or more embodiments, the transfer includes transferring one or more contracts 120 to acquire the asset. For example, in a case in which the Sponsor 105 is an airline, the transfer may include the transfer of one or more contracts with one or more providers to acquire jet fuel at specified prices or at a schedule of prices such that before the transfer the Sponsor 105 had the contracts with the one or more providers and after the transfer the PTMLP 115 has the contracts with the one or more providers.

In one or more embodiments, the transfer of the right to acquire the asset includes transferring a distribution asset 125. For example, in a case in which the Sponsor 105 is an airline, the transfer may include the transfer of assets that constitute a wholesale jet fuel distribution system, such as assets used to explore for, produce, refine, sell and/or distribute jet fuels. In such an example, the distribution asset 125 would belong to the Sponsor 105 before the transfer and to the PTMLP 115 after the transfer.

In one or more embodiment, the transfer of the right to acquire the asset includes transferring leverage 130 over the price of such assets. Such leverage 130 might arise, for example, out of the power over the price of the asset asserted by the Sponsor 105 because of the quantity of the asset purchased by the Sponsor 105. In such an example, the leverage 130 would belong to the Sponsor 105 before the transfer and to the PTMLP 115 after the transfer.

The PTMLP 115 acquires the asset at a first price (block 220) and sells the asset to the Sponsor 105 at a second price (block 225), wherein the second price is higher than the first price, to produce proceeds.

A valuation of the PTMLP 115 takes into account the proceeds. In one or more embodiments, the valuation of the PTMLP 115 is computed by multiplying a PTMLP multiple by an EBITDA for the PTMLP 115, wherein the EBITDA for the PTMLP 115 takes into account the proceeds.

A valuation of the Sponsor 105 is affected by the proceeds and by the Sponsor's share of the equity quantity of equity units in the PTMLP 115. In one or more embodiments, a valuation of the Sponsor 105 is computed by multiplying a Sponsor multiple, which is less than the PTMLP multiple, by the EBITDA for the Sponsor 105, and is affected by the effect on the EBITDA of the Sponsor 105 of the proceeds and by the Sponsor's share of the equity quantity of equity units in the PTMLP 115.

The arrangement shown in FIG. 1 produces a higher valuation for the Sponsor 105. An example will illustrate. Assume that an airline (Airline), operating before setting up the arrangement shown in FIG. 1, buys approximately 4 billion gallons of jet fuel annually at an average price of $2.56 per gallon for a total of $10.24 billion. This is an expense to Airline (assume that this is 30% of Airline's operating expense). Assume that Airline makes $40.248 billion in revenue in a given year. The 30% fuel costs imply that Airline's annual operating expenses are about $34.13 billion ($10.24 billion/0.30), which implies an EBITDA of $6.118 billion ($40.248 billion−$34.13 billion). Assume the market gives Airline a 5.0× valuation multiple on its EBITDA (i.e., a Sponsor multiple of 5). That implies a valuation of $30.590 billion ($6.118 billion×5).

Now, assume Airline adopts the structure shown in FIG. 1 and buys approximately 4 billion gallons of jet fuel from the PTMLP 115 at an average price of $2.61 (5 cents per gallon more) for a total of $10.44 billion, $200 million more than when Airline purchased the fuel directly. This is an expense to Airline. Assume the same revenue =$40.248 billion. The total operating expense is now $34.33 billion ($34.13 billion (computed above for the scenario without the structure show in FIG. 1)+$200 million)(this is $200 million more than before because of the higher price charged by the PTMLP). The implied EBITDA is $5.918 billion ($40.248 billion−$34.33 billion) and implying a valuation of $29.590 billion based on the 5.0× multiple on EBITDA ($5.918 billion×5), which is lower than that computed without the structure shown in FIG. 1.

However, the PTMLP 115 has revenue of $200 million from the sale of fuel to Airline at 5 cents per gallon above average price (i.e., 4 billion gallons×0.05/gallon). Assume for the purposes of these discussions that this amount drops straight to the EBITDA line. Assume the market gives the PTMLP 115a 12.0× PTMLP multiple on its EBITDA because it is a yield-based entity. That implies a valuation for the PTMLP of $2.4 billion. Assume Airline owns 70 percent of the PTMLP 115. As a result of adopting the structure, Airline has created $1.68 billion ($2.4 billion×0.70) in market value by allowing its affiliate PTMLP 115 to charge it an extra $200 million for fuel.

Adding this up, Airline's value is $29.590 billion and Airline's ownership of 70 percent of the PTMLP is worth $1.68 billion, which means Airline is worth $31.27 billion. Without the structure shown in FIG. 1, Airline is worth $30.590 billion. This means that Airline created $680 million in value by adopting the structure shown in FIG. 1.

In one or more embodiments, the PTMLP 115 sells a percentage of the equity quantity of equity units, in particular common units, through a stock exchange, such as the NYSE, to produce cash proceeds. The purchasers (i.e., the public) are the limited partners 135 of the PTMLP 115.

In one or more embodiments, the PTMLP 115 uses the cash proceeds to improve the PTMLP 115, for example by the purchase of capital equipment, real estate, or the like, and to make distributions to, or purchase assets from, the Sponsor 105.

In one or more embodiments, the PTMLP 115 uses the cash proceeds to purchase the right to acquire a new asset from the Sponsor 105. For example, in the airline example, the PTMLP 115 may use the cash proceeds to purchase the right to enter into additional contracts from the Sponsor 105 as the Sponsor's contracts with jet fuel providers expire or come up for renewal. The acquisition of such rights or assets is known as “drop-down” stories. Such drop-down stories tend to increase the valuation of the PTMLP 115 by, for example, increasing the PTMLP multiple.

In one or more embodiments, the equity quantity of equity units includes an incentive-distribution-right-unit quantity of incentive distribution right units. Incentive distribution right units are a schedule of distribution incentives for the GPE 110. In one or more embodiments, the incentive distribution right units are defined by tiers. Each tier is defined by a total distribution range and, for that distribution range, a percentage to be distributed to the holders of common units and a percentage to be distributed to the holders of subordinated units. Table 1 above is an example.

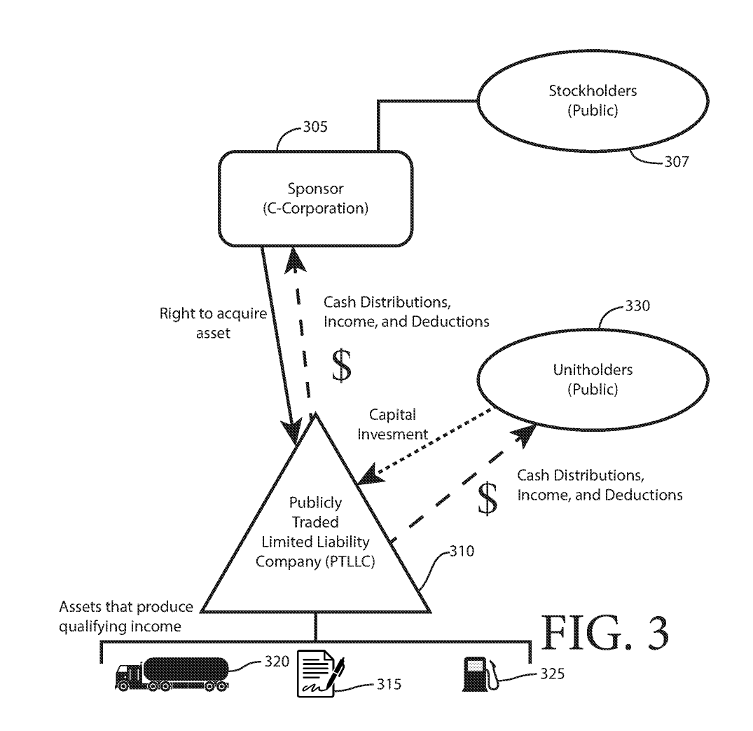

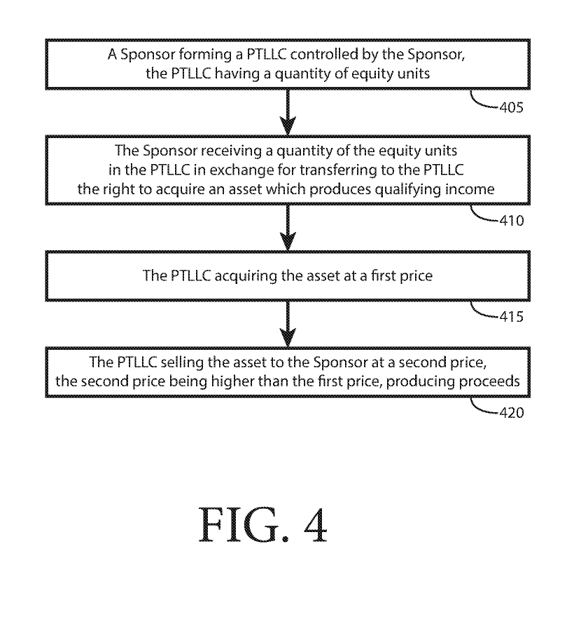

FIG. 3 is a chart showing a business structure in which the purchasing of an asset that produces qualifying income has been moved to an entity that qualifies for pass-through tax treatment. FIG. 4 is a flow chart for creating such a business structure.

A Sponsor 305, which may be a C-corporation and which may have stockholders 307 (i.e., the public), forms a publicly traded limited liability company (PTLLC) 310 controlled by the Sponsor 305 (block 405). The PTLLC 310 has a quantity of equity units. The Sponsor 305 receives a quantity of the equity units in the PTLLC 310 in exchange for transferring to the PTLLC 310 the right to acquire an asset which produces “qualifying income,” as defined in 26 USC 26 USC § 7704(d) (block 410). The PTLLC 310 acquires the asset at a first price (block 415) and sells the asset to the Sponsor 305 at a second price (block 420), to produce proceeds. The second price is higher than the first price. A valuation of the PTLLC 310 takes into account the proceeds. A valuation of the Sponsor 305 is affected by the proceeds and by the Sponsor's share of the PTLLC 310.

As with the PTMLP example illustrated in FIGS. 1 and 2, the right to acquire an asset can include one or more contracts 315, distribution assets 320, or leverage 325.

In one or more embodiments, the PTLLC 310 sells a percentage of the equity units through a stock exchange, such as the NYSE, to produce cash proceeds. The purchasers (i.e., the public) are the limited unitholders 330 of the PTLLC 310.

In one or more embodiments, the PTLLC 310 uses the cash proceeds to improve the PTMLP 115, for example by the purchase of capital equipment, real estate, or the like, and to make distributions to, or purchase assets from, the Sponsor 305.

In one or more embodiments, the PTLLC 310 uses the cash proceeds to purchase the right to acquire a new asset from the Sponsor 305.

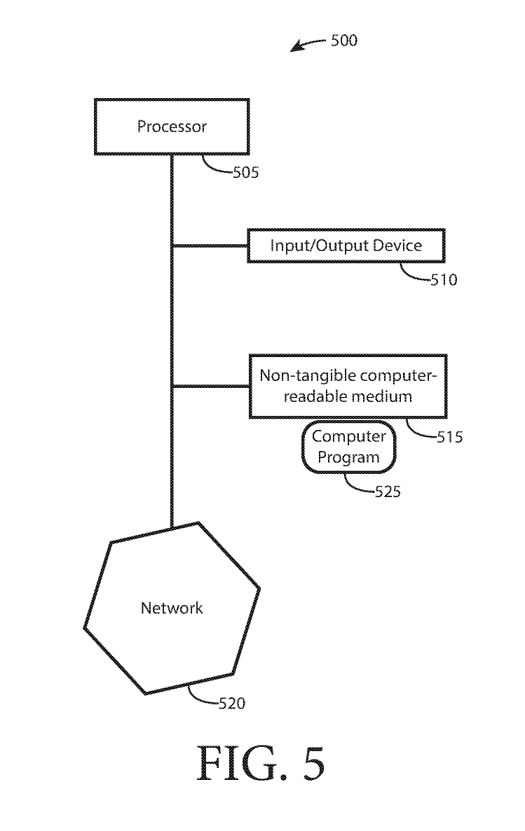

FIG. 5 is a block diagram of a computer. The computer 500 includes a processor 505 coupled to an input/output 510, which may include a keyboard, a mouse, a tablet, a stylus, a monitor, or any other input/output device, and a non-tangible computer-readable medium 515, which may be semiconductor memory, and optical memory device, a magnetic memory device, or any other similar device. The non-tangible computer-readable medium 515 may be accessed directly by the processor 505 or through the input/output 510. The computer 500 may be a tablet, a laptop, a desktop, a mainframe computer, a network of computers, or any other arrangement of computers required to perform the tasks described. The computer 500 may be connected to other computers through a network 520 such as a local area network, a wide area network, a virtual private network, or any similar network by which a number of computers are joined together.

In one embodiment, the non-tangible computer-readable medium 515 contains a computer program including executable instructions, that, when executed, determine an initial public offering (IPO) valuation of the PTMLP 115.

In one embodiment, the non-tangible computer-readable medium 515 contains a computer program including executable instructions, that, when executed, determine the first price at which the PTMLP 115 acquires the asset and a second price at which the PTMLP 115 sells the asset to the Sponsor 105 to produce proceeds.

In one embodiment, the non-tangible computer-readable medium 515 contains a computer program including executable instructions, that, when executed, determine an initial public offering (IPO) valuation of the PTLLC 310.

In one embodiment, the non-tangible computer-readable medium 515 contains a computer program including executable instructions, that, when executed, determine the first price at which the PTLLC 310 acquires the asset and a second price at which the PTLLC 310 sells the asset to the Sponsor 305 to produce proceeds.

In one aspect, a method includes a Sponsor, the Sponsor being a C-corporation, forming a general partner entity (GPE) owned and controlled by the Sponsor. The Sponsor forms a publicly traded master limited partnership (PTMLP) with the GPE as general partner of the PTMLP. The GPE has control over the PTMLP. The PTMLP has an equity quantity of equity units. The Sponsor receives a Sponsor-share portion of the equity quantity of equity units in the PTMLP in exchange for transferring to the PTMLP the right to acquire an asset which produces “qualifying income,” as defined in 26 USC § 7704(d). The PTMLP acquires the asset at a first price. The PTMLP sells the asset to the Sponsor at a second price, wherein the second price is higher than the first price, to produce proceeds. A valuation of the PTMLP takes into account the proceeds. A valuation of the Sponsor is affected by the proceeds and by the Sponsor-share of the equity quantity of equity units in the PTMLP.

Implementations may include one or more of the following. The GPE may be an entity selected from the group consisting of C-corporation, limited liability company, or limited partnership. The equity quantity of equity units may include a common-unit quantity of common units. The equity quantity of equity units may include a subordinated-unit quantity of subordinated units. The equity quantity of equity units may include an incentive-distribution-right quantity of incentive distribution right units. The valuation of the PTMLP may be computed by multiplying a PTMLP multiple by an earnings before interest, tax, depreciation and amortization (EBITDA) for the PTMLP, wherein the EBITDA for the PTMLP takes into account the proceeds. The valuation of the Sponsor may be computed by multiplying a C-corporation multiple, which is less than the PTMLP multiple, by the EBITDA for the Sponsor, and may be affected by the effect on the EBITDA of the Sponsor of the proceeds and of the Sponsor's share of the PTMLP. The PTMLP may sell a percentage of the equity quantity of equity units through a stock exchange to produce cash proceeds. The PTMLP may use the cash proceeds to improve the PTMLP. The PTMLP may use the cash proceeds to purchase the right to acquire a new asset from the Sponsor, wherein the PTMLP can purchase the new asset at a third price and sell the new asset to the Sponsor at a fourth price, the fourth price being higher than the third price. The GPE may have management and governance control over the PTMLP.

In one aspect, a method includes a Sponsor, the Sponsor being a C-corporation, forming a publicly traded limited liability company (PTLLC) controlled by the Sponsor. The PTLLC has a quantity of equity units. The Sponsor receiving a quantity of the equity units in the PTLLC in exchange for transferring to the PTLLC the right to acquire an asset which produces “qualifying income,” as defined in 26 USC 26 USC § 7704(d). The PTLLC acquiring the asset at a first price. The PTLLC selling the asset to the Sponsor at a second price, wherein the second price is higher than the first price, to produce proceeds. A valuation of the PTLLC takes into account the proceeds. A valuation of the Sponsor is affected by the proceeds and by the Sponsor's share of the PTLLC.

Implementations may include one or more of the following. The valuation of the PTLLC may be computed by multiplying a PTLLC multiple by an earnings before interest, tax, depreciation and amortization (EBITDA) for the PTLLC, wherein the EBITDA for the PTLLC takes into account the proceeds. The valuation of the Sponsor is computed by multiplying a C-corporation multiple, which is less than the PTLLC multiple, by the EBITDA for the Sponsor and is affected by the effect on the EBITDA of the Sponsor of the proceeds and of the Sponsor's share of the PTLLC.

The text above describes one or more specific embodiments of a broader invention. The invention also is carried out in a variety of alternate embodiments and thus is not limited to those described here. The foregoing description of an embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method comprising:
a Sponsor, the Sponsor being a C-corporation, forming a general partner entity (GPE) owned and controlled by the Sponsor;
the Sponsor:
forming a publicly traded master limited partnership (PTMLP) with the GPE as general partner of the PTMLP, the GPE having control over the PTMLP, the PTMLP having an equity quantity of equity units,
receiving a Sponsor-share portion of the equity quantity of equity units in the PTMLP in exchange for transferring to the PTMLP the right to acquire an asset which produces “qualifying income,” as defined in 26 USC § 7704(d);
the PTMLP acquiring the asset at a first price; and
the PTMLP selling the asset to the Sponsor at a second price, wherein the second price is higher than the first price, to produce proceeds;
wherein a valuation of the PTMLP takes into account the proceeds; and
wherein a valuation of the Sponsor is affected by the proceeds and by the Sponsor-share of the equity quantity of equity units in the PTMLP.

2. The method of claim 1 wherein the GPE is an entity selected from the group consisting of C-corporation, limited liability company, or limited partnership.

3. The method of claim 1 wherein the equity quantity of equity units comprises a common-unit quantity of common units.

4. The method of claim 1 wherein the equity quantity of equity units comprises a subordinated-unit quantity of subordinated units.

5. The method of claim 1 wherein the equity quantity of equity units comprises an incentive-distribution-right quantity of incentive distribution right units.

6. The method of claim 1 wherein:
the valuation of the PTMLP is computed by multiplying a PTMLP multiple by an earnings before interest, tax, depreciation and amortization (EBITDA) for the PTMLP, wherein the EBITDA for the PTMLP takes into account the proceeds; and
the valuation of the Sponsor, computed by multiplying a C-corporation multiple, which is less than the PTMLP multiple, by the EBITDA for the Sponsor , is affected by the effect on the EBITDA of the Sponsor of the proceeds and of the Sponsor's share of the PTMLP.

7. The method of claim 1 further comprising:
the PTMLP selling a percentage of the equity quantity of equity units through a stock exchange to produce cash proceeds.

8. The method of claim 7 further comprising the PTMLP using the cash proceeds to improve the PTMLP.

9. The method of claim 7 further comprising the PTMLP using the cash proceeds to purchase the right to acquire a new asset from the Sponsor, wherein the PTMLP can purchase the new asset at a third price and sell the new asset to the Sponsor at a fourth price, the fourth price being higher than the third price.

10. The method of claim 1 wherein the GPE has management and governance control over the PTMLP.

11. A method comprising:
a Sponsor, the Sponsor being a C-corporation, forming a publicly traded limited liability company (PTLLC) controlled by the Sponsor, the PTLLC having a quantity of equity units;
the Sponsor receiving a quantity of the equity units in the PTLLC in exchange for transferring to the PTLLC the right to acquire an asset which produces “qualifying income,” as defined in 26 USC 26 USC § 7704(d);
the PTLLC acquiring the asset at a first price; and
the PTLLC selling the asset to the Sponsor at a second price, wherein the second price is higher than the first price, to produce proceeds;
wherein a valuation of the PTLLC takes into account the proceeds; and
wherein a valuation of the Sponsor is affected by the proceeds and by the Sponsor's share of the PTLLC.

12. The method of claim 11 wherein:
the valuation of the PTLLC is computed by multiplying a PTLLC multiple by an earnings before interest, tax, depreciation and amortization (EBITDA) for the PTLLC, wherein the EBITDA for the PTLLC takes into account the proceeds; and
the valuation of the Sponsor is computed by multiplying a C-corporation multiple, which is less than the PTLLC multiple, by the EBITDA for the Sponsor and is affected by the effect on the EBITDA of the Sponsor of the proceeds and of the Sponsor's share of the PTLLC.
